(19) United States
(12) Patent Application Publication
(10) Pub. No.: US 2013/0048600 A1
(43) Pub. Date: Feb. 28, 2013

(54) VOLUMETRIC OPTICALLY VARIABLE DEVICES AND METHODS FOR MAKING SAME

(71) Applicant: Vitali PRISACAR, Roswell, GA (US)

(72) Inventor: Vitali PRISACAR, Roswell, GA (US)

(73) Assignee: CYBERNETIC INDUSTRIAL CORPORATION OF GEORGIA, Roswell, GA (US)

(21) Appl. No.: 13/553,142

(22) Filed: Jul. 19, 2012

Related U.S. Application Data
(60) Provisional application No. 61/525,894, filed on Aug. 22, 2011.

(51) Int. Cl. B29D 11/00

(52) U.S. Cl. 216/24; 264/2.7; 425/174.4; 29/557; 156/345.1

(57) ABSTRACT

The present invention provides a method for creating an optical feature, including: providing a substrate; creating one or more volumetric periodic/non-periodic structures on the substrate; and micromachining the one or more volumetric periodic/non-periodic structures on the substrate to create the optical feature. Optionally, the substrate is a photomaterial. The one or more volumetric periodic/non-periodic structures are aligned one or more of substantially perpendicular to, substantially parallel to, and substantially at an angle to the substrate. The one or more volumetric periodic/non-periodic structures have a predetermined frequency, orientation, and angle. Optionally, different portions of the one or more volumetric periodic/non-periodic structures are subjected to different degrees and/or shapes of micromachining.

### CROSS-REFERENCE TO RELATED APPLICATION

The present patent application/patent claims the benefit of priority of co-pending U.S. Provisional Patent Application No. 61/525,894, filed on Aug. 22, 2011, and entitled “VOLUME OPTICAL VARIABLE DEVICES AND METHODS FOR MAKING,” the contents of which are incorporated in full by reference herein.

### FIELD OF THE INVENTION

The present invention relates generally to volumetric optically variable devices (VOVDs) and methods for making the same. More specifically, the present invention relates to VOVDs and methods for making the same that include both volumetric periodic/non-periodic structure formation and surface micromachining steps.

### BACKGROUND OF THE INVENTION

Conventionally, a variety of techniques for producing holograms and other optically variable devices (OVDs) have been developed. These techniques generally involve utilizing the interference of two or more beams of coherent monochromatic light at the surface of a photosensitive material where the hologram or other OVD is produced. The monochromatic light is typically produced by a laser and, depending upon the desired result, the photosensitive material is chosen to produce a surface relief, gray scale, phase, or polarization holographic pattern. An OVD or VOVD is an iridescent image that exhibits various optical effects, such as movement and/or color changes. Advantageously, VOVDs cannot be photocopied or scanned, nor can they be accurately replicated or reproduced. Thus, VOVDs are often used as security devices and anti-counterfeiting measures on money, credit cards, government-issued identification cards, and the like. VOVDs are typically created through a combination of printing and embossing, and function via diffractive optical structures. Thus, different patterns, designs, and colors are created depending upon the amount of light striking a VOVD and the angle the VOVD is viewed at. Again, holograms are a type of VOVD.

VOVDs, in general, are optical devices that diffract, refract, transmit, absorb, and/or scatter light, and whose optical properties can vary within. Examples of VOVDs include holographic films, holograms, diffraction gratings, embossed films, embossing rolls, original artwork, replicas, and the like. Optically variable media (OVM) are optical media that diffract, refract, transmit, absorb, and/or scatter light and whose optical properties can vary within. Examples of OVMs, which can be used to make VOVDs, include polymers, polymer films, multilayer films, films with inclusions, films with embossing layers, photoresist, epoxies, silicones, lacquers, cellulose triacetate, glasses, and other optical materials.

Holograms of a variety of objects and patterns have been made using a single exposure to produce the desired final result. However, due to the expense and impracticality of the large optical systems needed, the size of these holograms is typically limited to about 1 square foot in size or smaller. Larger area holograms can be produced by a step-and-repeat procedure that tiles the object or pattern across the surface of the photosensitive material. This tiling, however, introduces seams or discontinuities between the adjacent areas, which are undesirable. To solve some of these problems, dot matrix holography was developed. In dot matrix holography, a larger holographic pattern is constructed by producing a large number of small holographic dots or pixels in a regular two-dimensional array. These holographic dots are on the order of 10's to 100's of microns in size, and there can be as few as 100 dots per linear inch or many as 2,000 or more dots per linear inch (i.e. 4,000,000 or more dots per square inch).

The fundamental principle of current dot matrix holography involves the use of a laser beam, which is first split into two beams. These two beams are then recombined at the recording material to create an interference pattern in a small area (i.e. holographic dots). Changing the angle and orientation of the intersecting beams controls the period and orientation of the resultant gratings produced in the recording material. Writing many thousands of these dots with the desired properties, in a similar manner to how a dot matrix printer formerly created a printed image, produces complex dot matrix holographic designs. The system, which produces the dot matrix holograms, is typically computer controlled. In each dot, a grating is written with a desired grating period, grating depth, and/or grating orientation. In this manner, virtually any pattern can be produced. Because, each dot is controlled, the viewing angle, brightness, and/or color content of each dot can be adjusted. This allows a variety of visual effects to be produced. Brightness control, for example, allows gray scale or color images to be made. Kinetic effects can make an image appear to move or change as the hologram is tilted or the viewer shifts position. Three-dimensional effects can be made which make an image appear to come out of or be recessed into the surface of the hologram.

Current dot matrix holography, however, has numerous important limitations with respect to viewing angle, number of lines on the OVM, color, and the like that may be achieved. Thus, what are still needed in the art are devices and methods that allow more robust and flexible holograms and other OVDs to be produced, in an efficient and practical manner.

### BRIEF SUMMARY OF THE INVENTION

In various exemplary embodiments, the present invention provides VOVDs and methods for making the same that include both volumetric periodic/non-periodic structure formation and surface micromachining steps, such that more robust and flexible holograms and other OVDs are produced, in an efficient and practical manner.

In one exemplary embodiment, the present invention provides a method for creating an optical feature, including: providing a substrate; creating one or more volumetric periodic/non-periodic structures on the substrate; and micromachining the one or more volumetric periodic/non-periodic structures on the substrate to create the optical feature. Optionally, the substrate is a photomaterial. The one or more volumetric periodic/non-periodic structures are aligned one or more of substantially perpendicular to, substantially parallel to, and substantially at an angle to the substrate. The one or more volumetric periodic/non-periodic structures have a predetermined frequency, orientation, and playback angle. Optionally, different portions of the one or more volumetric periodic/non-periodic structures are subjected to different degrees and/or shapes of micromachining. The one or more volumetric periodic/non-periodic structures are created on the substrate by, for example, a setup using the Denisiyk technique, which includes two beams interacting with a photomaterial from the opposite side—with beam structure, orientation, and angle being variable. The micromachining of the one or more volumetric periodic/non-periodic structures is performed by laser, mechanical, and/or chemical techniques, for example.

In another exemplary embodiment, the present invention provides a method for creating an optical feature, including: providing a substrate; micromachining the substrate; and creating one or more volumetric periodic/non-periodic structures on the micromachined substrate to create the optical feature. Optionally, the substrate is a photomaterial. The one or more volumetric periodic/non-periodic structures are aligned one or more of substantially perpendicular to, substantially parallel to, and substantially at an angle to the micromachined substrate. The one or more volumetric periodic/non-periodic structures have a predetermined frequency, orientation, and playback angle. Optionally, different portions of the substrate are subjected to different degrees and/or shapes of micromachining. The one or more volumetric periodic/non-periodic structures are created on the micromachined substrate by, for example, a setup using the Denisiyk technique, which includes two beams interacting with a photomaterial from the opposite side—with beam structure, orientation, and angle being variable. The micromachining of the one or more volumetric periodic/non-periodic structures is performed by laser, mechanical, and/or chemical techniques, for example.

In a further exemplary embodiment, the present invention provides a system for creating an optical feature, including: a substrate; a first device operable for creating one or more volumetric periodic/non-periodic structures on the substrate; and a second device operable for micromachining the one or more volumetric periodic/non-periodic structures on the substrate to create the optical feature. Optionally, the substrate is a photomaterial. The first device operable for creating one or more volumetric periodic/non-periodic structures on the substrate includes, for example, a setup using the Denisiyk technique, which includes two beams interacting with a photomaterial from the opposite side—with beam structure, orientation, and angle being variable. The second device operable for micromachining the one or more volumetric periodic/non-periodic structures includes a laser, mechanical, and/or chemical setup, for example. Optionally, the first device and the second device are the same device operated in different modes.

In a still further exemplary embodiment, the present invention provides a system for creating an optical feature, including: a substrate; a first device operable for micromachining the substrate; and a second device operable for creating one or more volumetric periodic/non-periodic structures on the micromachined substrate to create the optical feature. Optionally, the substrate is a photomaterial. The second device operable for creating the one or more volumetric periodic/non-periodic structures on the micromachined substrate includes, for example, a setup using the Denisiyk technique, which includes two beams interacting with a photomaterial from the opposite side—with beam structure, orientation, and angle being variable. The first device operable for micromachining the substrate includes a laser, mechanical, and/or chemical setup, for example. Optionally, the first device and the second device are the same device operated in different modes.

### BRIEF DESCRIPTION OF THE DRAWINGS

The present invention is illustrated and described herein with reference to the various drawings, in which like reference numbers are used to denote like device components/method steps, as appropriate, and in which:

FIG. 1 is a schematic diagram illustrating one exemplary embodiment of the VOVD system of the present invention;

FIG. 2 is a flowchart illustrating one exemplary embodiment of the VOVD method of the present invention;

FIG. 3 is a series of schematic diagrams illustrating examples of volumetric periodic/non-periodic structures utilized in conjunction with the VOVD systems and methods of the present invention;

FIG. 4 is a series of schematic diagrams illustrating examples of beam incident angles utilized in conjunction with the VOVD systems and methods of the present invention;

FIG. 5 is a series of schematic diagrams illustrating examples of volumetric periodic/non-periodic structure creation and surface micromachining for different angled volumetric periodic/non-periodic structures utilizing the VOVD systems and methods of the present invention; and

FIG. 6 is a series of schematic diagrams illustrating examples of volumetric periodic/non-periodic structure creation and surface micromachining for substantially parallel volumetric periodic/non-periodic structures utilizing the VOVD systems and methods of the present invention.

### DETAILED DESCRIPTION OF THE INVENTION

In various exemplary embodiments, the present invention relates to the creation of VOVDs utilizing a multi-step approach, including both volumetric periodic/non-periodic structure creation and surface micromachining. Thus, the present invention relates to a new type of VOVD structure, and a method for forming the same, based on a combination of dot matrix, volumetric holography, and laser selective micromachining concepts. The present invention introduces a method for originating a new class of VOVD micro/nanostructures by applying a two-step process—volumetric periodic/non-periodic structure recording and selective surface micromachining, both utilizing specific, controlled parameters.

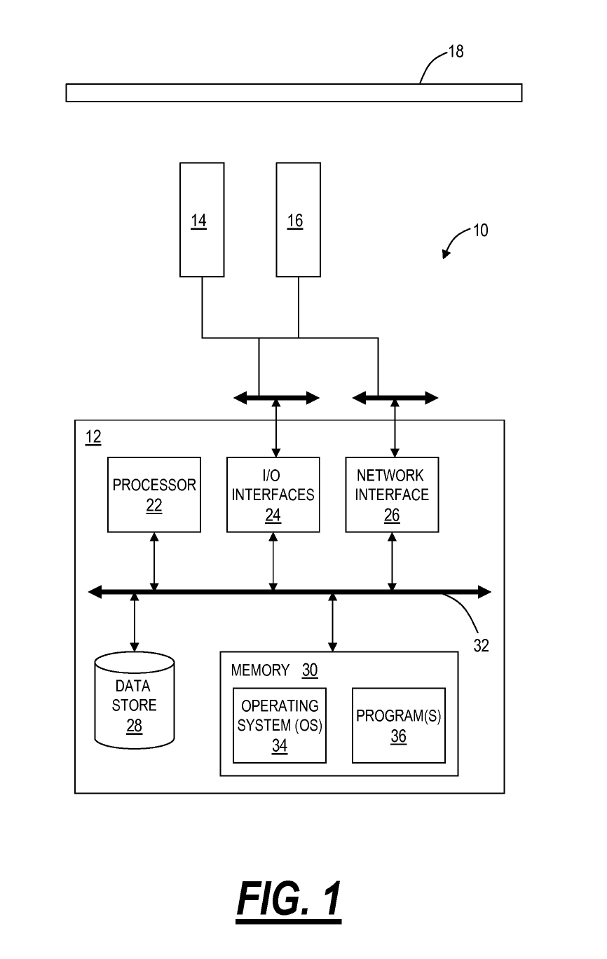

Referring to FIG. 1, in one exemplary embodiment of the present invention, the VOVD system 10 generally includes a computer 12, a first VOVD creation device 14, a second VOVD creation device 16, and a material 18 for writing thereon. The computer 12 is communicatively coupled to the first VOVD creation device 14 and the second optical VOVD creation device 16 for the precise control thereof. The first VOVD creation device 14 and the second VOVD creation device 16 are collectively configured to create a VOVD on/in the material 18. In an exemplary embodiment, the material 18 includes an OVM, such as, but not limited to, a polymer, a polymer film, a multilayer film, a films with inclusion, a films with embossing layers, a photoresist, an epoxy, a silicone, a lacquer, cellulose triacetate, a glass, and/or other optical material on which a two or three-dimensional image may be generated, such optical materials being well known to those of ordinary skill in the art. The display written on the material 18 can include, but is not limited to, a holographic film, a hologram, a diffraction grating, an embossed film, an embossing roll, an original artwork, a replica, and/or the like.

The computer 12 is a digital computer that, in terms of hardware architecture, generally includes a processor 22, input/output (I/O) interfaces 24, a network interface 26, a data store 28, and a memory 30. It will be appreciated by those of ordinary skill in the art that FIG. 1 depicts the computer 12 in an oversimplified manner, and a practical embodiment of the computer 12 would include additional components and suitably configured processing logic to support conventional or known operating features that are not described in detail herein. The components 22, 24, 26, 28, and 30 are communicatively coupled via a local interface 32. The local interface 32 may be, for example, but is not limited to, one or more buses or other wired or wireless connections, well known to those of ordinary skill in the art. The processor 22 is a hardware device for executing software instructions. The processor 22 may be any custom made or commercially available processor, a central processing unit (CPU), an auxiliary processor among several processors associated with the computer 12, a semiconductor-based microprocessor (in the form of a microchip or chip set), or generally any device for executing software instructions. The I/O interfaces 24 are used to receive user input from and/or for providing system output to one or more other devices or components. In an exemplary embodiment, the optical VOVD creation devices 14 and 16 are communicatively coupled to the I/O interfaces 24.

The network interface 26 is used to enable the computer 12 to communicate on a network, such as the Internet, a wide area network (WAN), a local area network (LAN), and/or the like. In an exemplary embodiment, the optical VOVD creation devices 14 and 16 are communicatively coupled to the network interface 26, either directly or indirectly, via intervening equipment. A data store 28 is used to store data. The data store 28 may include any of volatile memory elements, nonvolatile memory elements, and combinations thereof. The memory 30 may include any of volatile memory elements, nonvolatile memory elements, and combinations thereof. The software in the memory 30 may include one or more software programs, each of which includes an ordered listing of executable instructions for implementing logical functions. The software in the memory 30 includes, for example, a suitable operating system (OS) 34 and one or more other programs 36. The OS 34 essentially controls the execution of other computer programs, such as the one or more other programs 36, and provides scheduling, input-output control, file and data management, memory management, and communication control and related services. The one or more programs 36 may be configured to implement the various processes, algorithms, methods, techniques, etc. described herein associated with controlling the optical VOVD creation devices 14 and 16.

The first VOVD creation device 14 is configured to create volumetric periodic/non-periodic structures on the material 18 in a specific manner or pattern, as controlled by the computer 12. The first VOVD creation device 14 includes, for example, a setup using the Denisiyk technique, which includes two beams interacting with a photomaterial from the opposite side—with beam structure, orientation, and angle being variable. The second VOVD creation device 16 is configured to micromachine the material 18 in a specific manner or pattern, as also controlled by the computer 12. The second VOVD creation device 16 includes a laser, mechanical, and/or chemical setup, for example, such as a light source, a light intensity modulation device, and a beam positioning device. In an exemplary embodiment, the first VOVD creation device 14 is configured to create the volumetric periodic/non-periodic structures, and then the second VOVD creation device 16 is configured to micromachine the volumetric periodic/non-periodic structures. In another exemplary embodiment, the second VOVD creation device 16 is configured to micromachine the material 18, and then the first VOVD creation device 14 in configured to create the volumetric periodic/non-periodic structures on the micromachined material. Micromachining can be based on a chemical reaction with or following the development of the material 18, or by mechanical or laser ablation of the surface of the material 18, for example. Note, while shown in FIG. 1 as being separate devices, the first VOVD creation device 14 and the second VOVD creation device 16 may be a single device utilized for both creating volumetric periodic/non-periodic structures and micromachining.

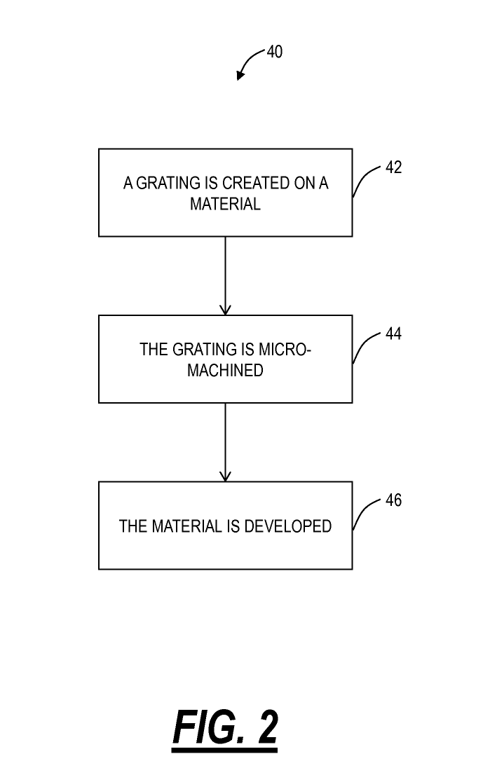

Referring to FIG. 2, in one exemplary embodiment of the present invention, VOVD method 40 includes two steps—creating a volumetric periodic/non-periodic structure on the material 18 (FIG. 1) (step 42) and micromachining the volumetric periodic/non-periodic structure (step 44). The volumetric periodic/non-periodic structure on the material 18 is a VOVD device that includes a plurality of pixels tilted at specific angles. In an exemplary embodiment, the pixels may be formed using dot matrix techniques or the like. Each pixel has a high-frequency volumetric grating (HFVG), of around 3000 l/mm, for example. The playback angle for the HFVG is very high, and at some high (e.g. >2000 l/mm) grating frequencies, a reflected beam lies on the surface plane where grating is recorded and, because of that, is not visible. To correct this issue, a surface with volumetric gratings has a tilt to a specific angle depending on the grating pitch. In the VOVD method 40 of the present invention, the tilted surface is created by optically micromachining the pixeled surface (step 44). After micromachining, the photo material may be developed (step 46). After developing, the surface of the material 18 has a complex structure, i.e. a volumetric grating written on tilted surface, for example.

The VOVD method 40 of the present invention may be utilized to create new types of VOVDs based on the selective micromachining of individual pixels, or groups of pixels, recorded by dot matrix techniques or the like, with the goal to create a blazed grating profile for sending all light to one order, for example. The VOVD method 40 of the present invention may also be utilized to create new types of VOVDs based on a dot matrix blazed structure or the like, with an ability to create sharp channel separation for multichannel images, or color switch effects with sharp color separation.

In general, the volumetric periodic/non-periodic structures are utilized to make an image and the color associated therewith. In particular, the volumetric periodic/non-periodic structures are formed over specific areas with selected individual optical characteristics such as, but not limited to, grating frequency, orientation, and playback angle. In an exemplary embodiment of the present invention, to adjust the playback angle and/pre-send different colors in the same direction, the second step 44 is applied, i.e. micromachining of the surface, with the goal of achieving a specific angle needed for color matching on an image or pattern appearance.

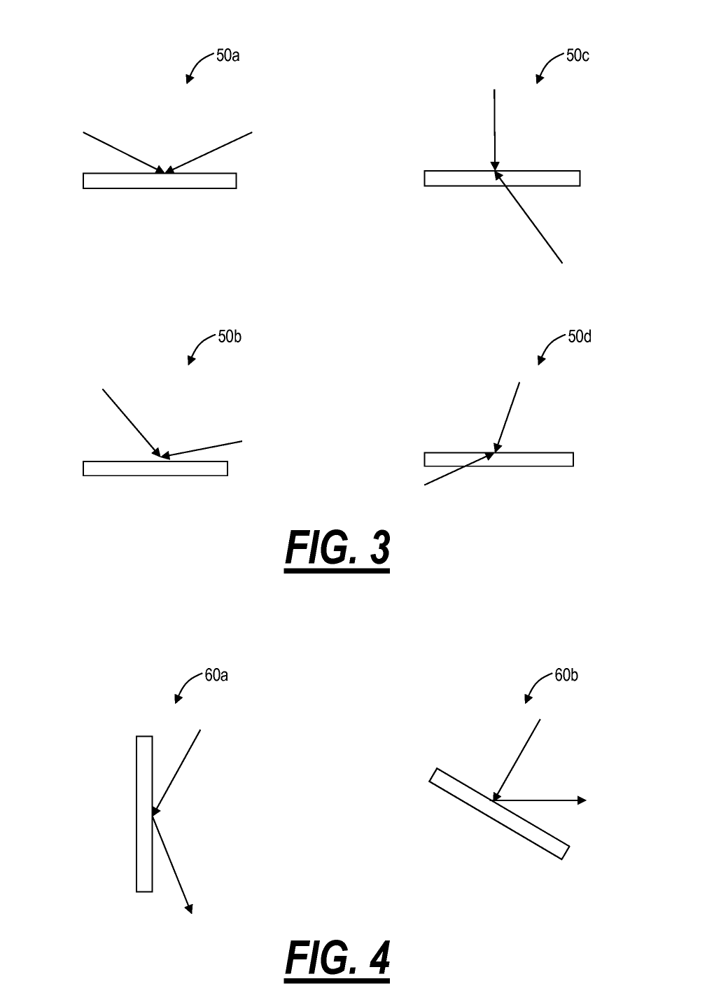

Referring to FIGS. 3 and 4, in an exemplary embodiment, various examples are illustrated of a volumetric periodic/non-periodic structure 50 and beam incident angles 60 for the VOVDs of the present invention. In FIG. 3, four examples are illustrated of volumetric periodic/non-periodic structures 50 (labeled as 50a, 50b, 50c, and 50d). In an exemplary embodiment, the volumetric periodic/non-periodic structures 50a, 50b, 50c, and 50d are recorded by applying light beams from the opposite side of or from the same side of a plate or other substrate with photoresist (e.g. photomaterial). The volumetric periodic/non-periodic structures 50a, 50b, 50c, and 50d are generated using the first VOVD creation device 14 (FIG. 1). The volumetric periodic/non-periodic structure 50a illustrates two incident beams on the plate from approximately opposing angles on the same side. The volumeric periodic/non-periodic structure 50b illustrates two incident beams on the plate from different opposing angles on the same side. The volumetric periodic/non-periodic structure 50c illustrates two incident beams on the plate from opposing sides with different angles. The volumetric periodic/non-periodic structure 50d also illustrates two incident beams on the plate from opposing sides with different angles. The beams' incident angles can be symmetric or asymmetric with reference to the plate in all cases. The beams' incident angles can be changed together or separately for color selection. The color of pixels in the volumetric periodic/non-periodic structures 50 can be controlled in two ways. First, by changing the angle between beams, and, second, by changing the tilting angle of the pixel surface. By tilting the angle of the pixel surface it is possible to send different colors in specific directions.

In an exemplary embodiment, the first VOVD creation device 14 may include a plurality of beams for projection onto the surface of the material 18. The image or pattern or specific optical or non-optical structure is recorded into the material 18 in a pixel-by-pixel fashion. HFVGs can be recorded first, and second the pixel surface can micromachined, or the pixel surface can be micromachined first, and the volumetric periodic/non-periodic structures recorded second. Lastly, exposed and/or unexposed areas of the material 18 are removed, based upon the particular material, by developing it or by ablating it.

FIG. 4 illustrates the result of the VOVD systems and methods 10 (FIG. 1) and 40 (FIG. 2) of the present invention where the control of the playback angles 60a, 60b of the material 18 is enabled. For example, based upon the control of the optical VOVD creation 14 and 16, the material 18 can have a symmetric or asymmetric playback angle. For example, the playback angle 60a illustrates a symmetric example, whereas the playback angle 60b illustrates an asymmetric example.

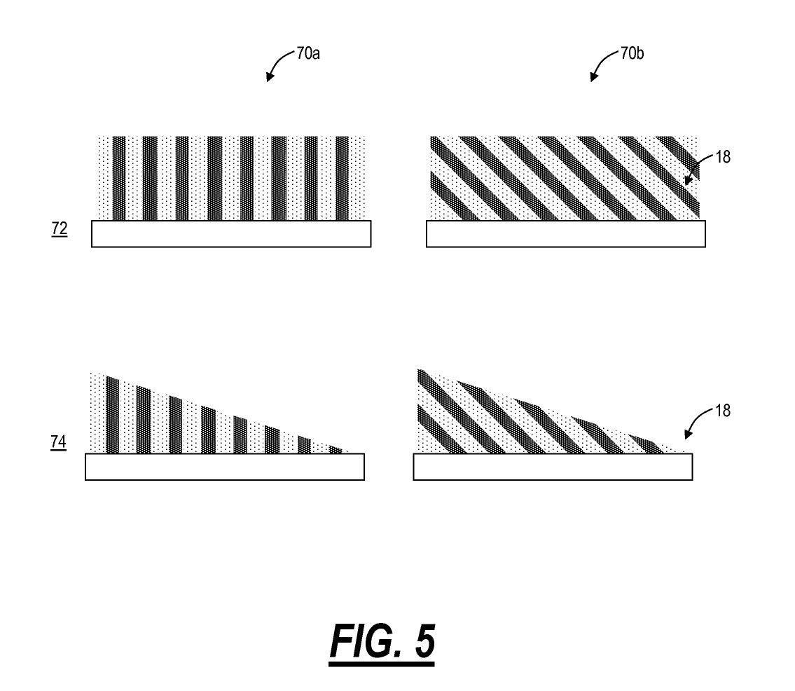

Referring to FIG. 5, in another exemplary embodiment, the material 18 is illustrated after the two respective steps. The VOVD 70a includes periodic/non-periodic structures formed in a substantially vertical orientation, whereas the VOVD 70b includes periodic/non-periodic structures formed in an angled orientation. As will be readily apparent to those of ordinary skill in the art, any and all other suitable orientations are possible and may be utilized. The first step 72 illustrates the material 18 following the formation of the volumetric periodic/non-periodic structures. The second step 74 illustrates the material 18 with the formed volumetric periodic/non-periodic structures following micromachining. By tailoring and combining periodic/non-periodic structure frequency, periodic/non-periodic structure tilt angle, and micromachining angle(s), overall structures can be shaped in a blazed grating fashion for maximum efficiency and a specific manner and order of playback. Tilted surfaces can be flat or any desirable shape, for example. This includes, but is not limited to, micro-optics, such as lenses, prisms, and/or mirrors. By using this technique, it is possible to create colored optical and non-optical microelements of a wide variety.

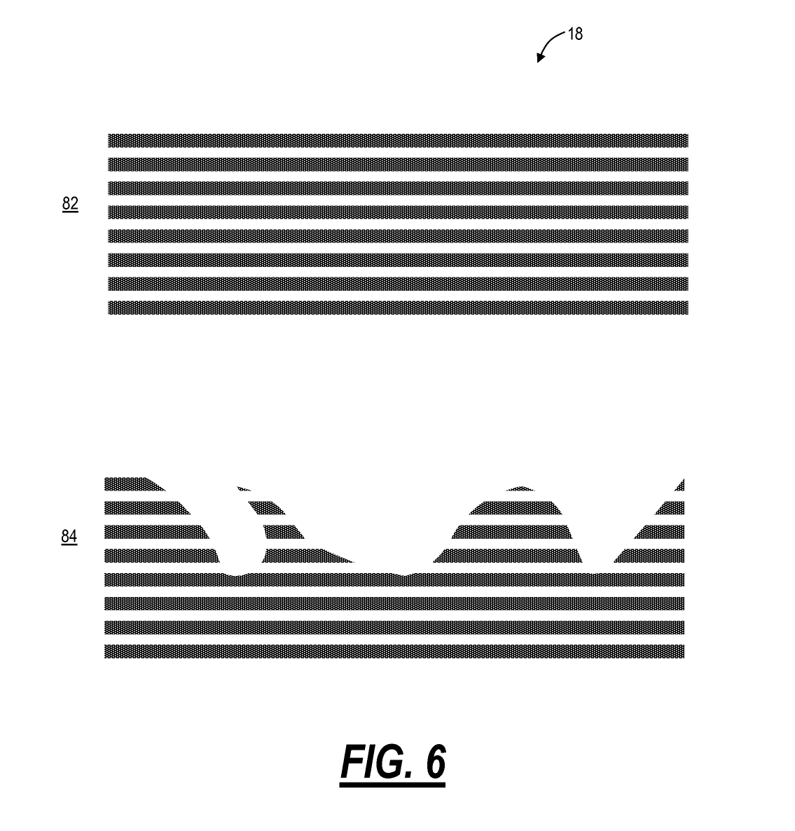

Referring to FIG. 6, in another exemplary embodiment, the material 18 is illustrated with the volumetric periodic/non-periodic structures substantially parallel to the material 18, and with micromachining performed to selectively remove layers of the material 18 and the volumetric periodic/non-periodic structures. Similarly to FIG. 5, the material 18 is subjected to two steps 82 and 84. In the first step 82, volumetric periodic/non-periodic structures in the material 18 are created and exposed in such way that periodic/non-periodic structure plane is parallel to the photomaterial plate. In the second step 84, by applying selected angular and tilting angle micromachining to the volumetric periodic/non-periodic structure, it is possible to create a wide variety of images. Here, the volumetric periodic/non-periodic structures can be recorded on an optical plate over all photomaterial volume at once from the opposite side of the photomaterial, for example, so that the volumetric periodic/non-periodic structures are parallel to the photomaterial surface, and then, by applying the second step 84, selective micromachining, a color image can be created by assigning different tilting and orientation angles to individual pixels or groups of pixels, for example. In the case of a volumetric periodic/non-periodic structure recorded parallel to the underlying surface, planes of equal refraction index waveguides or optical channels can be created.

Advantageously, the volumetric periodic/non-periodic structure VOVDs and methods of the present invention may be utilized in various applications to create high-frequency VOVDs (3-4,000 l/mm, for example) with tilted pixels, with an entire image being the same color, and/or the like. Using the systems and methods described herein, micro-optical elements and colored optical elements can be created—such as lenses, prisms, mirrors, etc. of specific colors, for example. Additionally, using the systems and methods described herein, waveguides with special functions, e.g. optical frequency separation, can be created.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for creating an optical feature, comprising:
providing a substrate;
creating one or more volumetric periodic/non-periodic structures on the substrate; and
micromachining the one or more volumetric periodic/non-periodic structures on the substrate to create the optical feature.

2. The method of claim 1, wherein the substrate comprises a photomaterial.

3. The method of claim 1, wherein the one or more volumetric periodic/non-periodic structures are aligned one or more of substantially perpendicular to, substantially parallel to, and substantially at an angle to the substrate.

4. The method of claim 1, wherein the one or more volumetric periodic/non-periodic structures have a predetermined frequency, orientation, and playback angle.

5. The method of claim 1, wherein different portions of the one or more volumetric periodic/non-periodic structures are subjected to different degrees and/or shapes of micromachining.

6. The method of claim 1, wherein the one or more volumetric periodic/non-periodic structures are created on the substrate by a system utilizing interacting beams of radiation.

7. The method of claim 1, wherein the micromachining of the one or more volumetric periodic/non-periodic structures is performed by one or more of an optical technique and a mechanical technique.

8. A method for creating an optical feature, comprising:
providing a substrate;
micromachining the substrate; and
creating one or more volumetric periodic/non-periodic structures on the micromachined substrate to create the optical feature.

9. The method of claim 8, wherein the substrate comprises a photomaterial.

10. The method of claim 8, wherein the one or more volumetric periodic/non-periodic structures are aligned one or more of substantially perpendicular to, substantially parallel to, and substantially at an angle to the micromachined substrate.

11. The method of claim 8, wherein the one or more volumetric periodic/non-periodic structures have a predetermined frequency, orientation, and playback angle.

12. The method of claim 8, wherein different portions of the substrate are subjected to different degrees and/or shapes of micromachining.

13. The method of claim 8, wherein the one or more volumetric periodic/non-periodic structures are created on the micromachined substrate by a system utilizing interacting beams of radiation.

14. The method of claim 8, wherein the micromachining of the substrate is performed by one or more of an optical technique and a mechanical technique.

15. A system for creating an optical feature, comprising:
a substrate;
a first device operable for creating one or more volumetric periodic/non-periodic structures on the substrate; and
a second device operable for micromachining the one or more volumetric periodic/non-periodic structures on the substrate to create the optical feature.

16. The system of claim 15, wherein the substrate comprises a photomaterial.

17. The system of claim 15, wherein the first device operable for creating one or more volumetric periodic/non-periodic structures on the substrate comprises a device utilizing interacting beams of radiation.

18. The system of claim 15, wherein the second device operable for micromachining the one or more volumetric periodic/non-periodic structures comprises one or more of an optical device and a mechanical device.

19. The system of claim 15, wherein the first device and the second device are the same device operated in different modes.

20. A system for creating an optical feature, comprising:
a substrate;
a first device operable for micromachining the substrate; and
a second device operable for creating one or more volumetric periodic/non-periodic structures on the micromachined substrate to create the optical feature.

21. The system of claim 20, wherein the substrate comprises a photomaterial.

22. The system of claim 20, wherein the second device operable for creating the one or more volumetric periodic/non-periodic structures on the micromachined substrate comprises a device utilizing interacting beams of radiation.

23. The system of claim 20, wherein the first device operable for micromachining the substrate comprises one or more of an optical device and a mechanical device.

24. The system of claim 20, wherein the first device and the second device are the same device operated in different modes.
